(19) United States
(12) Patent Application Publication
(10) Pub. No.: US 2014/0249929 A1
(43) Pub. Date: Sep. 4, 2014

(54) ADVERTISEMENT MATCHING PLATFORM

(71) Applicant: AdBuddy Inc., Clayton, NC (US)

(72) Inventor: Devin F. Delane, Clayton, NC (US)

(73) Assignee: AdBuddy Inc., Clayton, NC (US)

(21) Appl. No.: 14/187,268

(22) Filed: Feb. 22, 2014

Related U.S. Application Data
(60) Provisional application No. 61/768,745, filed on Feb. 25, 2013.

(51) Int. Cl. G06Q 30/02

(52) U.S. Cl. CPC G06Q 30/0267
USPC 705/14.64

(57) ABSTRACT

A computerized customer managed offer matching system configured to match advertising and criterion queries in a computer network. In one embodiment, the matching system receives a request to display advertisement(s) on a mobile device. The request can specify a desired condition of display of an advertisement, a desired condition including one or more of match terms, geographic origins of the match terms, time of searches for the match term, and/or placement of advertisements.

### CROSS REFERENCE TO RELATED APPLICATION

This non-provisional application claims the benefit of provisional application No. 61/768,745, filed Feb. 25, 2013, which application is incorporated herein in its entirety by this reference.

### BACKGROUND

The present invention relates generally to online advertising. More specifically, the present invention provides a customer managed offer matching system which focuses on catering to the specific needs and wants of each individual customer such that advertisements encountered by the customer are reflective of those wants.

Product marketing has long been an important part of any good business model. In order for any product or service to succeed, that product or service must be brought to the attention of potential customers; potential customers who are the most likely to purchase that product or service. Even the best products and services have to be advertised effectively, or they are ultimately doomed to failure as word of mouth is simply not enough for a product to succeed on a large scale in the modern world. In the modern world, there are many different forms of advertising that are utilized by businesses and marketing companies in an attempt to reach potential customers.

One of the biggest issues with advertising is reaching a group of people which are most likely to want to buy a specific product or service. If the group of people most likely to be interested in a product are successfully reached, then the more likely it is for that product to be successful and profitable. The method of advertising to specific groups of people to maximize product profitability is called targeted advertising and is used across many different forms media.

Take magazines, television, and internet websites as example forms of media. A magazine may be known to have a specific demographic of readers and the advertisements contained within are chosen in response to those demographics. For example, a fashion magazine may have a reader demographic comprised mostly of middle aged females. In response to this, the advertisements found in the fashion magazine may consist of makeup, beauty products, clothing, shoes, and accessories. All of these categories of product are most likely to be interesting to the middle aged female demographic. Another good example of this targeted advertising technique would be a science fiction television channel. Such a science fiction television channel may have a viewer demographic that is largely comprised of young males. As a result, it is ideal for advertisements for products such as gadgets, video games, action movies, and computers to appear on such a science fiction television channel. The same techniques are followed online, where a website will often feature ads that are targeted for their specific audience.

Although targeted advertising is in some ways very effective, it is an outdated technique that does not take very good advantage of the capabilities offered by modern technology. Most advertising techniques and systems in use today are passive, attempting to reach potential customers through demographic statistical analysis and targeted advertising. Such methodologies and systems are inefficient for the rapidly growing area of internet advertising.

Therefore, there is an urgent need for customer managed offer matching systems which actively analyzes the customers inputs and presents the customer with advertisements that are based upon a number of different past and real time parameters. Past parameters may include saved search queries or information input into the system by the user. Real time parameters may include information such as customer location which is capable of being determined using modern mobile devices such as smart phones. Such offer matching systems should break down these past and real time parameters into logical groups such that they can be analyzed and used to present customers with advertisements that they are most likely to have an interest in.

### SUMMARY

To achieve the foregoing and in accordance with the present invention, systems and methods for online advertising is provided. More specifically, the present invention provides a customer managed offer matching system which focuses on catering to the specific needs and wants of each individual customer via selective advertisements.

A computerized customer managed offer matching system configured to match advertising and criterion queries in a computer network. The system receives a request to display an advertisement on a mobile device, the request specifying at least one desired condition of display of an advertisement, at least one desired condition including one or more of match terms, geographic origins of the match terms, time of searches for the match term, and/or placement of advertisement(s).

The system may also receive a request to display an advertisement, the request specifying at least one desired condition of display of an advertisement, the at least one desired condition including one or more of a selected number of searches for a selected search term for a first selected time period, a first price for displaying the advertisement for a specified time period per a third selected number of impressions, a selected number of times the advertisement is displayed for a second selected time period, a selected number of times the advertisement is clicked on for a third selected time period, and/or geographic restrictions on where the advertisement is displayed.

In some embodiments, the system matches customer criterion queries with businesses criterion offers by, for example, matching match terms, geographic origins of customer, time of criterion queries, placement of advertisements, customer profile criterion, consumer profile and/or proximity of business.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a conceptual display of several of the devices which may be utilized by embodiments of the present invention;

FIG. 2 is a conceptual display of the various locations for the devices of FIG. 1;

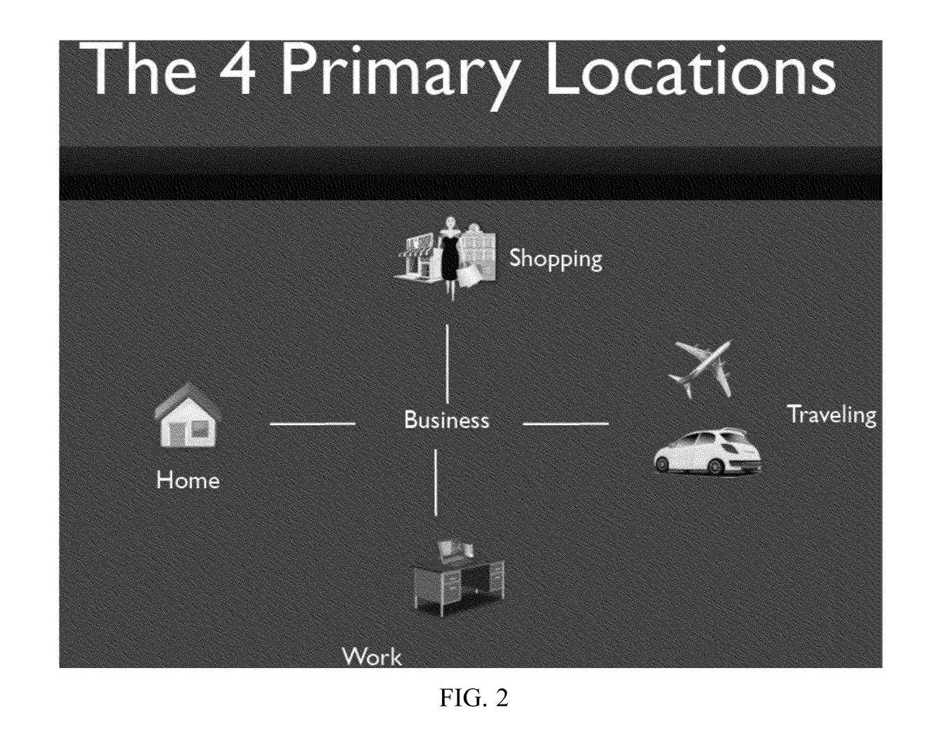

FIG. 3 is a conceptual display of how embodiments of the present invention may be utilized in different locations and accessed through different devices;

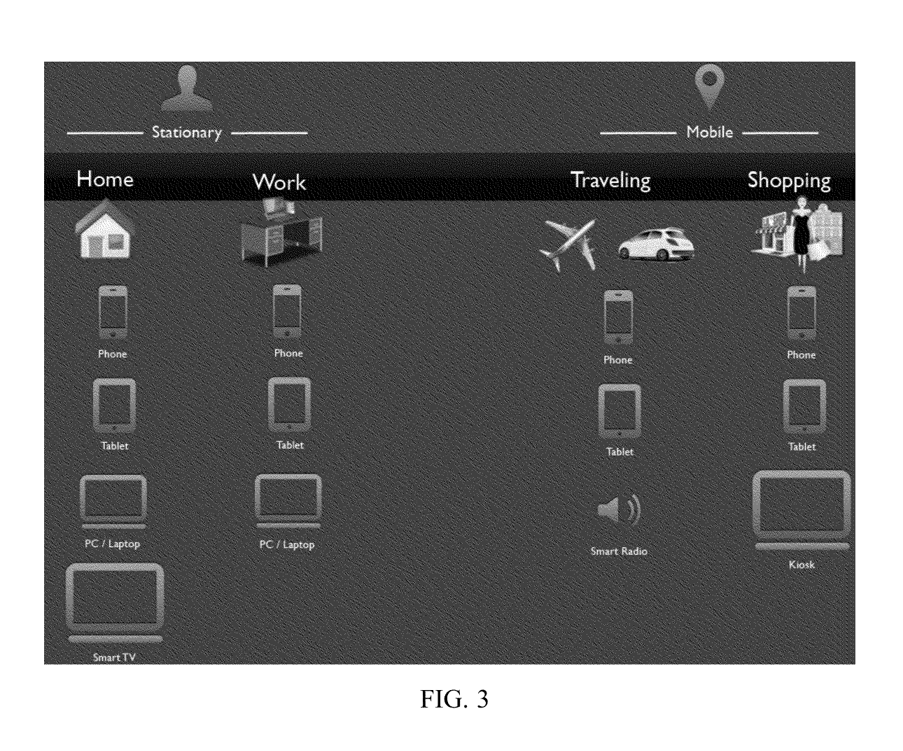

FIG. 4 is a conceptual display of the four layers of one exemplary embodiment of the present invention;

FIG. 5 is a conceptual display of how the customer may set the beacons for the embodiment of FIG. 4;

FIG. 6 is a conceptual display of how the brand beacons affect the embodiment of FIG. 4 as the customer moves around;

FIG. 7 is an example of some of the brands that the customer may choose;

FIG. 8 is a conceptual display of how the want and need beacons affect the embodiment of FIG. 4 as the customer moves around;

FIG. 9 is a flow chart depicting integrated marketing that may be used with embodiments of the present invention;

FIG. 10 is an example of how a user interface for the embodiment of FIG. 4 may look;

FIG. 11 is a flow chart depicting how embodiments of the present invention affects advertisements encountered during searches;

FIG. 12 is a flow chart depicting how embodiments of the present invention operates when using location data to display advertisements to the user;

FIG. 13 is another flowchart depicting a similar process; and

FIG. 14 is a conceptual depiction of how embodiments of the present invention may be organized into a network in order to function.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

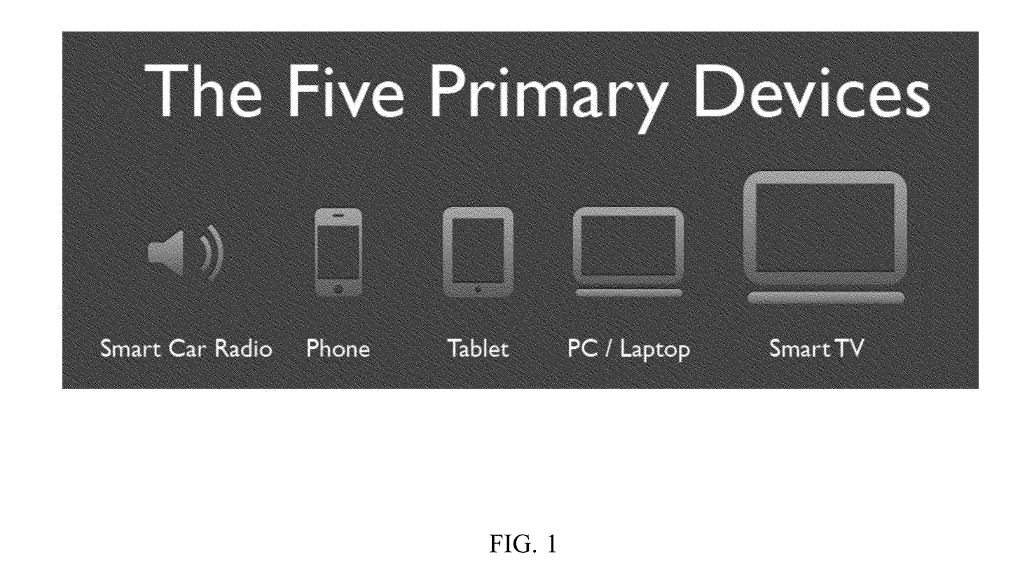

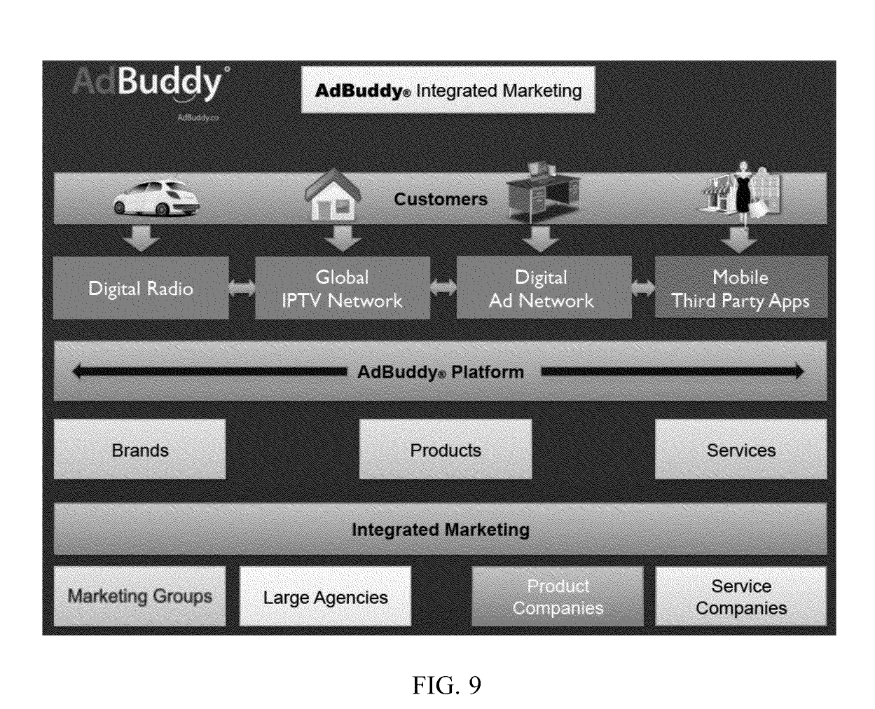

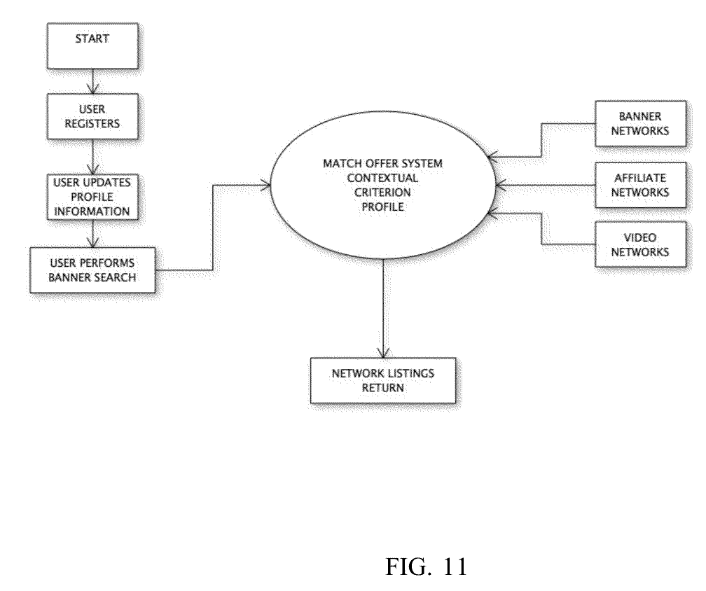

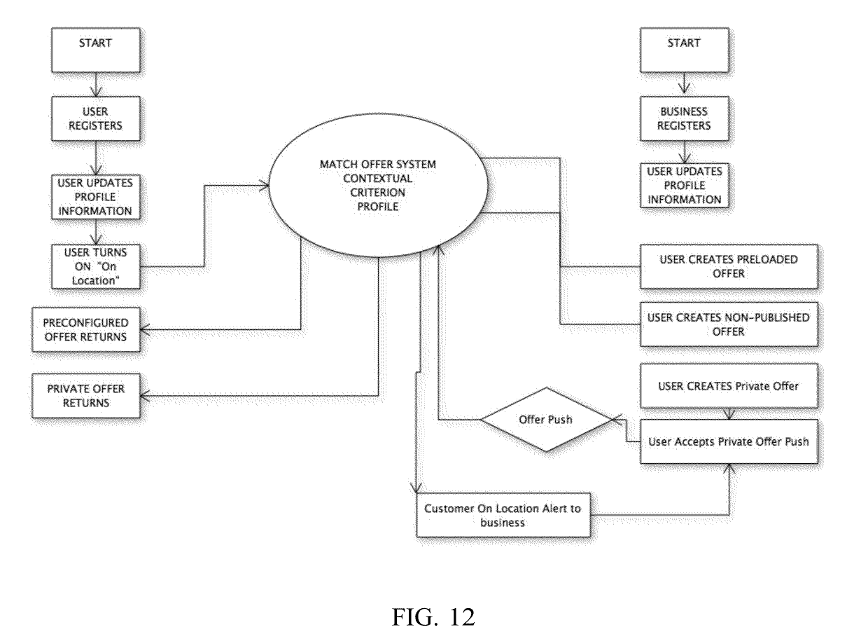

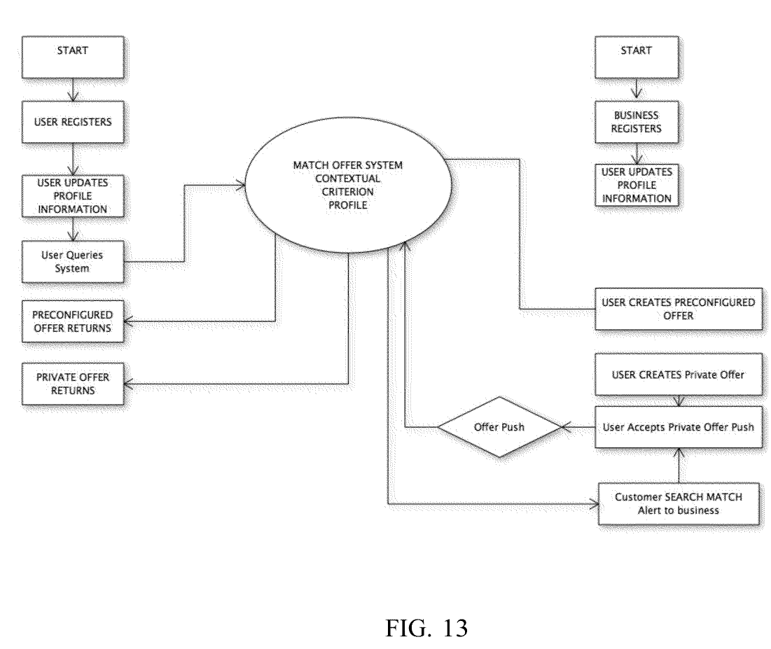

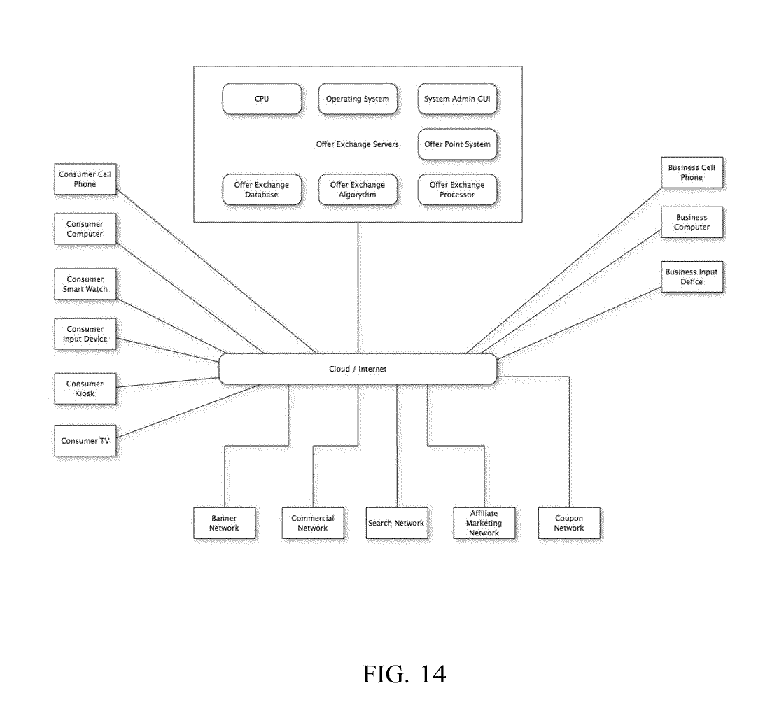

FIG. 14 is conceptual depiction of how embodiments of the present invention may be organized into a network, while FIG. 1 is a conceptual display of several exemplary devices which may be utilized by embodiments of the present invention. In addition, FIGS. 9, 11, 12 and 13 are flow diagrams illustrating the operations and features of one embodiment of the present invention, for example, using location data to display advertisements to the user.

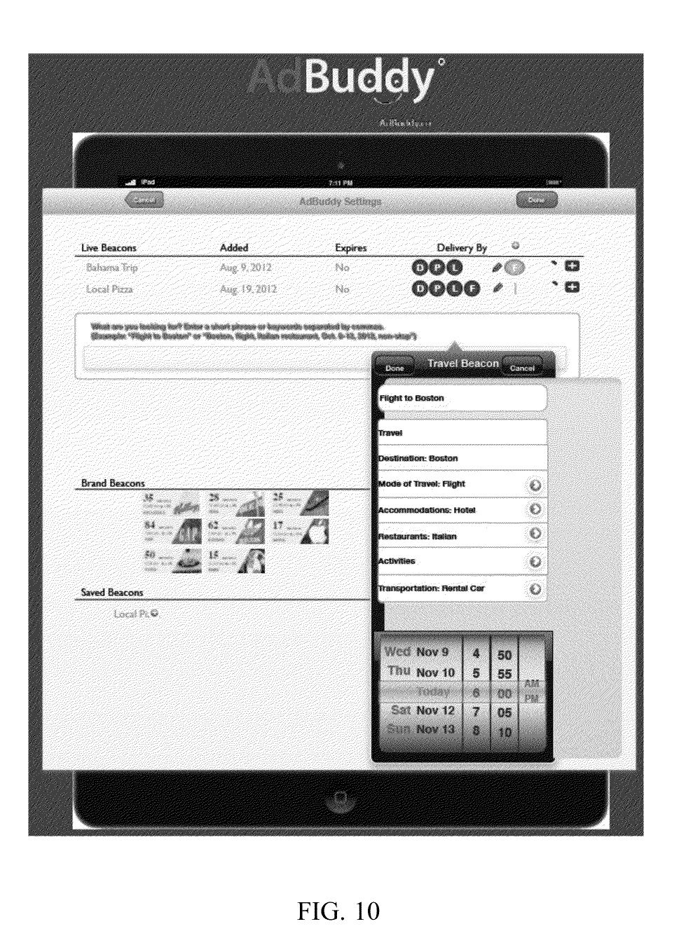

In this embodiment, a customer managed offer matching system comprises a computerized platform that is broken down into multiple different logical subgroups which are used in determination of the most appropriate advertisements to display to a user. The logical subgroups comprise a historical information subgroup, and a real time information subgroup. These two logical subgroups contain information and parameters that are used to determine what advertisements are displayed to the user, as illustrated by FIG. 10. The historical information subgroup comprises information that is gathered over time pertaining to the customer and information that is input directly into the system by the customer. The Information that is gathered by the system about the customer primarily comprises a log of search queries that are made by the user. The search queries made by the customer are logged and saved such that this information may be used by the system to determine what kinds of advertisements the customer may be interested in viewing. The search queries may be collected by the system across multiple different websites to ensure that the system records a complete picture of the interests of the customer. The customer may view the search queries as collected by the system at any time through a user interface. The user interface displays saved search queries to the customer and allows the customer to delete any of the search queries that are no longer relevant to them. This is necessary as some search queries may become pointless to use in the determination of what advertisements are displayed to the customer. For example, if the customer searches for a laptop computer on various retailing websites, and then buys a laptop computer, it does not make any sense for those search queries to affect advertisements displayed to the customer. The search query should be removed as the customer has already purchased a laptop computer and is no longer interested in seeing advertisements for them.

The historical information subgroup also comprises information that is input directly into the system by the customer via the user interface. This information comprises three specific groups that are referred to as beacon groups; a brand beacon group, a want beacon group, and a need beacon group. Each beacon group contains different information that pertains to what kinds of products the customer is interested in. The brand beacon group contains information about all of the different specific brands that the customer likes. The brand beacon group influences what types of offers are presented to the customer. For example, if the customer has Coca-Cola listed as one of their favored brands under the brand beacon group, the customer will be shown a variety of different advertisements and special offers pertaining to Coca-Cola products. These advertisements and offers can help the customer get the best price whenever they are shopping for their favorite brands of product.

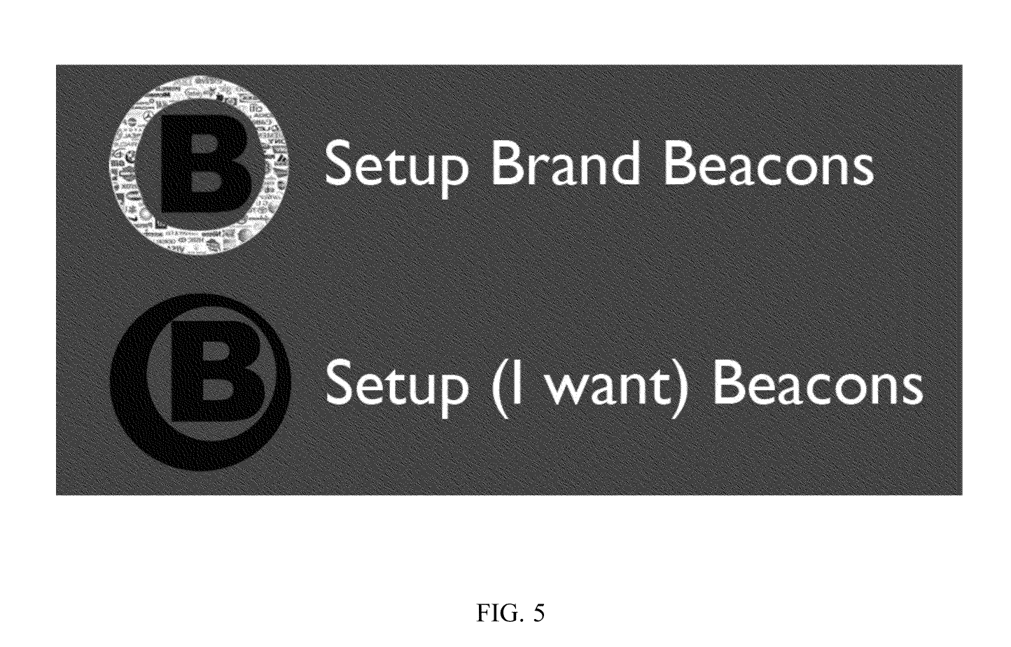

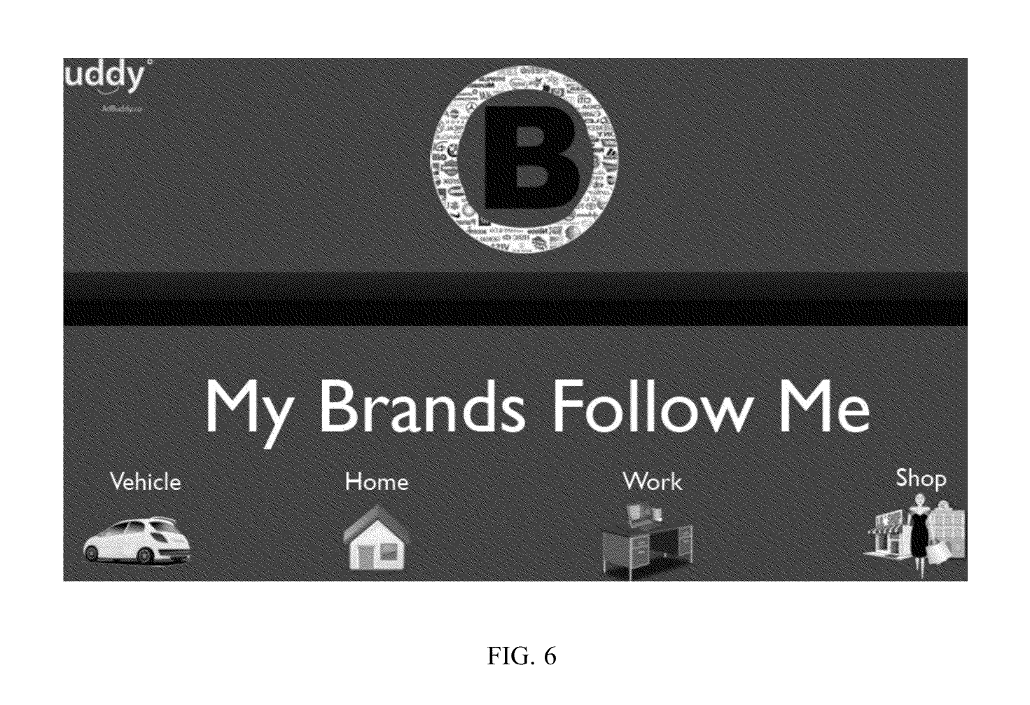

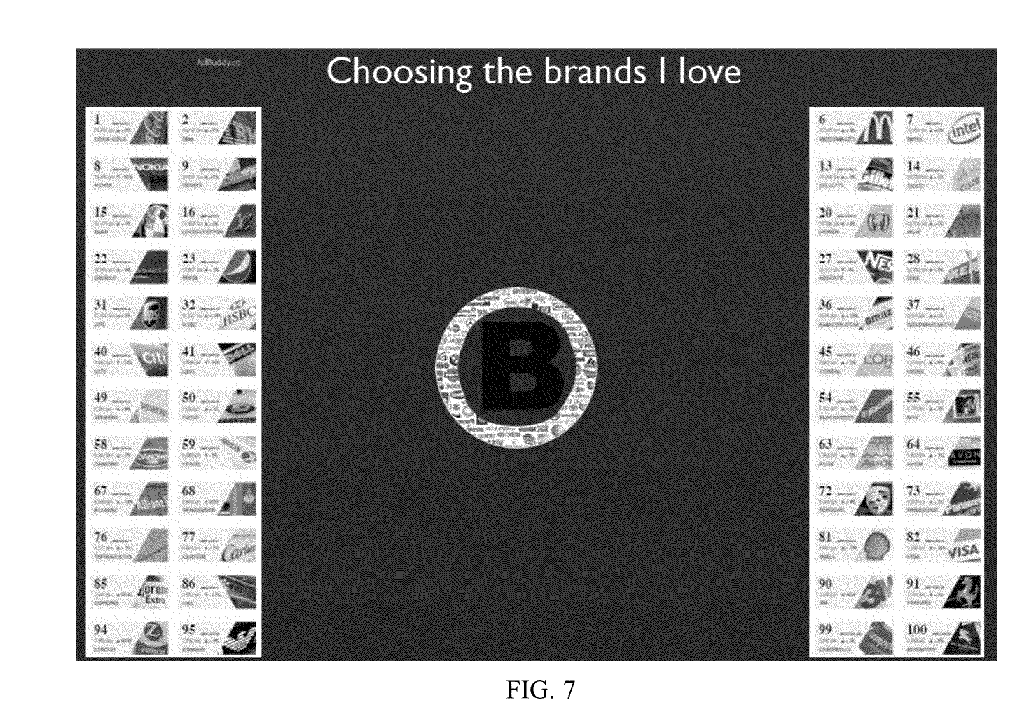

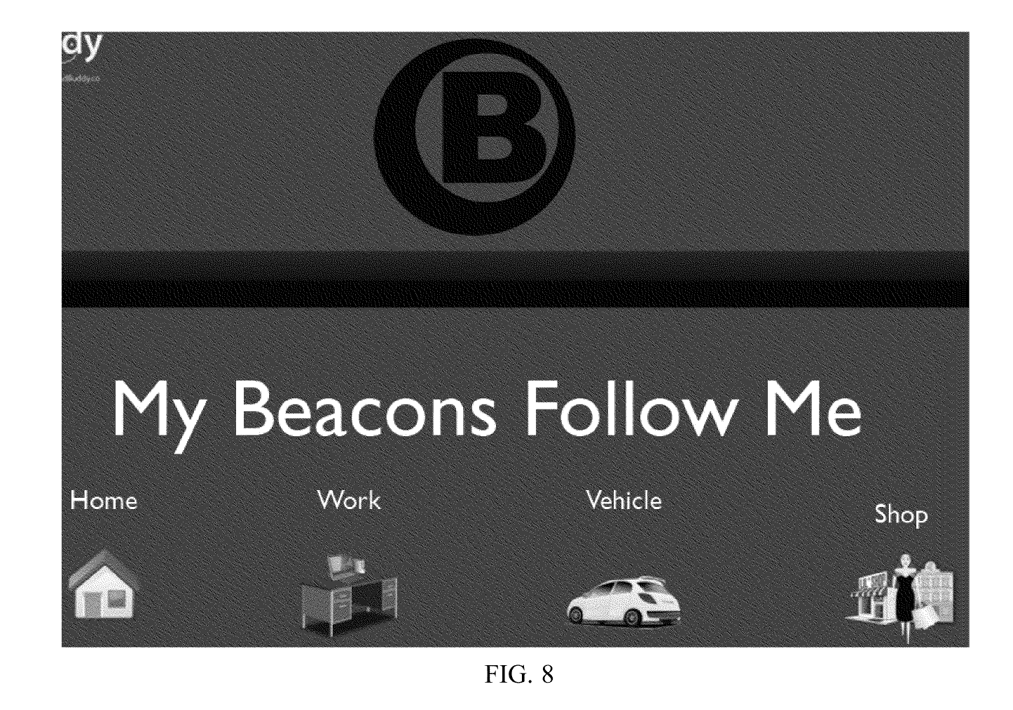

Referring to the exemplary display screens of FIGS. 5, 6, 7 and 8, the want beacon group includes information that relates to what kinds of products the user wants. Embodiments of the present invention uses this information to actively search out the advertisements and special offers relating to the products listed in the want beacon group. For example, if the customer has a computer listed under the want beacon group, the embodiment is affected such that it displays advertisements related to computers and also displays and special offers for computers. The customer is free to modify the products listed in the want beacon group at any time through the user interface.

The need beacon group is very similar to the want beacon group however the need beacon group is reserved for products and services that the customer actually needs. For example, a new phone model may be listed under the want beacon group whereas a car repair may be listed under the need beacon group. The customer wants a new phone, but they need a car repair. This allows embodiments of the present invention to perform some prioritization of what advertisements are most readily seen by the user. As a result, the customer can get their car fixed as quickly and as cheaply as possible with the help of the present invention and then remove the car repair from the need beacon group. Since the need beacon group has a higher priority than the want beacon group and as such more drastically affects the advertisements that are displayed to the user, it is expected that the need beacon group may remain empty for much of the time an embodiment of the present invention is in use.

The real time information subgroup comprises location data that is fed into the system by a mobile device. Embodiments of the present invention include but are not limited to mobile devices such as smart phones, tablet computers, smart car radios, and laptop computers. These devices are capable of determining their position through a variety of different methods, and that information is transmitted to the system so that it may be used to determine where the user is. This location information is tied in with and compared against the historical information to determine if there are any products in proximity to the user that they may be interested in purchasing.

Embodiments of the present invention can also include a user display, as illustrated by the exemplary screenshot of FIG. 10. The user display is responsible for displaying advertisements to the user and is affected by the logical subgroups described above. The logical subgroups serve as the inputs for embodiments of the present invention, collecting information to be used in the output which is the user display.

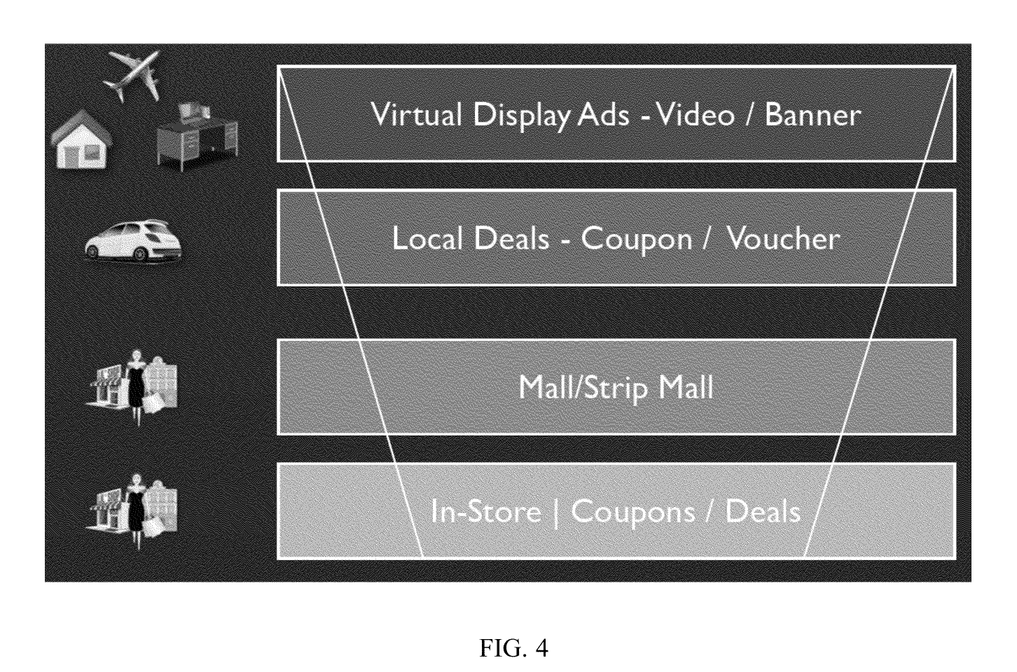

Referring now to exemplary screenshot of FIG. 4, the user display comprises four different layers which are a virtual layer, a local layer, a mall layer, and an in-store layer. Each of these layers corresponds to a different scale at which the present invention is delivering advertisements to the customer.

The virtual layer is the most general and overarching layer. Furthermore the virtual layer is always active for any customer who is using an embodiment of the present invention. Whenever the customer browses the internet from a device that is registered with the system, the advertisements they see on various websites will be determined based upon the historical information stored for that particular customer. As a result, the customer only sees advertisements for products they are interested in buying no matter what websites they browse on. All forms of online advertisement are covered in the virtual layer including but not limited to video ads and banner ads. The virtual layer generally only makes use of the historical information as the customer most likely browses the internet from a stationary location. However it is possible that the virtual layer be affected by real time location information if the customer is browsing the internet from a mobile device. In such a scenario, the customer would see advertisements that are relevant to both their personal product interests and to their physical location, meaning that those products can be bought within close proximity of the customer's location.

The local layer uses a proximity scale that is most appropriate for when the customer is traveling by car. In the local layer, the customer is shown advertisements that are within fairly close driving range to their location. The local layer uses both the historical information and the real time information to determine where the user is, what products they are interested in, and what products are available within driving range of the customer's present location. As a result, the local layer can make it much easier for the customer to find products they are looking for in an unfamiliar area. The local layer can also help the customer find new products in a familiar area more efficiently, thus saving the customer time and energy when they are shopping. The remaining two layers of the user display operate much in the same way as the local layer, however at decreasing scales.

The mall layer is scaled to be helpful to the customer in a shopping area that includes many retail stores within walking distance of one another, also known as a mall or strip mall. When the customer is traveling through a mall on foot, they are traveling in an area that is appropriate to use the mall layer. The mall layer uses the historical information to determine what products the customer may be interested in and cross references that information with the real time information. Thus, the present invention is able to determine when the customer is in close proximity to retail stores which sell products they are interested in and any advertisements the customer sees on their mobile device are adjusted accordingly. The in-store layer works almost exactly the same way, however it operates at the level of a single store. This means that as the customer walks around the store, they will be able to use their mobile device to view both advertisements and special offers, both of which are customized to the customer's specific preferences as can be determined by analysis of the historical information.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for matching advertising and criterion queries in a computer network, the method comprising:
receiving a request to display an advertisement on a mobile device, the request specifying at least one desired condition of display of an advertisement, at least one desired condition including at least one of the following:
i) a match term;
ii) a geographic origin of the match term;
iii) time of search for the match term; and
iv) placement of an advertisement.

2. A computerized method of receiving a request to display an advertisement, the request specifying at least one desired condition of display of an advertisement, the at least one desired condition including at least one of the following:
i) a selected number of searches for a selected search term for a first selected time period;
ii) a first price for displaying the advertisement for a specified time period per a third selected number of impressions;
iii) a selected number of times the advertisement is displayed for a second selected time period;
iv) a selected number of times the advertisement is clicked on for a third selected time period; and
v) geographic restrictions on where the advertisement is displayed.

3. The method of claim 2 further comprising collecting offer criterion from the consumers.

4. The method of claim 2 further comprising collecting offer advertisement from the sellers.

5. The method of claim 2 further comprising matching a consumer criterion and sellers advertisement.

6. The method of claim 2 further comprising facilitating transactions and offers between customers and sellers.

7. The method of claim 2 further comprising arranging for presentation of offers to users of computers or other computerized devices.

8. A computerized method for matching customers criterion queries with businesses criterion offers, the method comprising matching at least one of the following:
i) match terms;
ii) geographic origins of customer;
iii) time of criterion queries;
iv) placement of advertisements;
v) customer profile criterion;
vi) consumer profile; and
vii) proximity of business.

9. The method of claim 8 further comprising signaling a proximity match between a business offer and a customer query, resulting in a consumer alert.

10. The method of claim 8 further comprising an advertiser influencing a position of an offering in the consumers query results by creating offering relevant criteria.

11. The method of claim 8 further comprising the advertiser entering the criteria and the description into a listing.

12. The method of claim 8 further comprising influencing at least in part the position for the listing within a results page.

13. The method of claim 8 further comprising notifying when a customer that matched the search criterion.

14. The method of claim 8 further comprising sending a private offer to a customer.

15. The method of claim 8 further comprising maintaining location awareness of a customer in motion.

16. The method of claim 8 further comprising creating one or more private offers by alerting businesses a customer has activated a signal within a customer criterion and location parameter.

17. The method of claim 8 further comprising parsing at least one private offer to list either of a product and a service.

18. The method of claim 8 further comprising maintaining the offer in a history of offers.

19. The method of claim 8 further comprising detecting the activation of a private offer element within a second computerized device.

20. The method of claim 8 further comprising monitoring populations of users within a proximity constraint.
